(19) United States
(12) Patent Application Publication
(10) Pub. No.: US 2022/0206488 A1
(43) Pub. Date: Jun. 30, 2022

(54) AUTONOMOUS ITEM DELIVERY

(71) Applicant: Divergent Technologies, Inc., Los Angeles, CA (US)

(72) Inventors: Kevin Robert CZINGER, Santa Monica, CA (US); Greg WEAVER, Los Angeles, CA (US); Narender Shankar LAKSHMAN, Hermosa Beach, CA (US)

(21) Appl. No.: 17/561,472

(22) Filed: Dec. 23, 2021

Related U.S. Application Data
(60) Provisional application No. 63/130,574, filed on Dec. 24, 2020.

(51) Int. Cl. G05D 1/00; G05D 1/10; G05D 1/02

(52) U.S. Cl. CPC G05D 1/0011; G05D 1/0088; H04L 67/125; G05D 1/0212; G05D 1/028; G05D 1/101

(57) ABSTRACT

An autonomous delivery vehicle (ADV) may include multiple storage compartments, and each storage compartment of the plurality of storage compartments has a respective storage space and is associated with a respective delivery location. The respective storage space of each storage compartment may store one or more items. Each storage compartment may transition from a first state to a second state, and the first state may prevent access to the storage space of the respective storage compartment and the second state may enable access to the respective storage space of the respective storage compartment. The ADV may further include a receiver configured to receive first information from a computing system remote and external to the first ADV, and the first ADV may autonomously travel to one or more locations based on the first information.

### CROSS REFERENCE TO RELATED APPLICATION(S)

This application claims the benefit of U.S. Provisional Application Ser. No. 63/130,574, entitled “Autonomous Item Delivery” and filed on Dec. 24, 2020, the disclosure of which is expressly incorporated by reference herein in its entirety.

### BACKGROUND

### Technical Field

The present disclosure generally relates to delivery apparatuses, systems and method; more particularly, the present disclosure provides one or more techniques for autonomously delivering an item to a location.

### Introduction

An autonomous vehicle is a vehicle that is capable of collecting inputs indicative of its surrounding environment and navigating through the surrounding environment with little to no human input. Examples of autonomous vehicles include self-driving cars, drones and other unmanned aerial vehicles (UAVs), etc.

Autonomous vehicles utilize a number of various inputs to sense the surrounding environment, some of which may be derived from sensors while others may be received over a network. For example, an autonomous vehicle may employ one or more of the following: radio detection and ranging (radar), light detection and ranging (LIDAR, sometimes referred to as “laser imaging, detection, and ranging), a global positioning system (GPS) or other global navigation satellite system, odometry, inertial sensors and measurements, still images or video, and so forth. Utilizing such sensory input, an autonomous vehicle may navigate through an environment while avoiding collisions.

In current applications, the usefulness of autonomous vehicles may be largely limited to transport of people, as at least one person may be expected to pilot an autonomous vehicle, for example, in order to assume control of the autonomous vehicle in the event some error occurs or if some instructions are unrecognized. However, the usefulness of unmanned vehicles outside of this context remains relatively untapped.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect of the disclosure, a first autonomous delivery vehicle (ADV) is provided. The first ADV may include plurality of storage compartments, wherein each storage compartment of the plurality of storage compartments has a respective storage space, wherein each storage compartment of the plurality of storage compartments is associated with a respective delivery location, wherein the respective storage space of each storage compartment is configured to store one or more items, wherein each storage compartment is configured to transition from a first state to a second state, and wherein the first state of each respective storage compartment is configured to prevent access to the storage space of the respective storage compartment and the second state of each respective storage compartment is configured to enable access to the respective storage space of the respective storage compartment. The first ADV may further include a receiver configured to receive first information from a computing system remote and external to the first ADV, wherein the first ADV is configured to autonomously travel to one or more locations based on the first information.

In another aspect of the disclosure, a second ADV is provided. The second ADV may include a storage compartment having a storage space configured to store at least one item destined for delivery to one or more delivery locations, wherein the storage compartment transitions from a first state to a second state based on authentication information received from an independent authenticator, wherein the first state of the storage compartment is configured to prevent access to the storage space and the second state of the storage compartment is configured to enable access to the storage space. The second ADV may further include a receiver configured to receive first information from a computing system remote and external to the ADV, wherein the ADV is configured to autonomously travel to the one or more delivery locations based on the first information.

In even another aspects of the present disclosure, a first delivery system is provided. The first delivery system may include a first ADV. The first delivery system may further include a plurality of delivery pods, wherein each delivery pod comprises a plurality of storage compartments, wherein each storage compartment of the plurality of storage compartments is associated with a respective delivery location, wherein each storage compartment of the plurality of storage compartments has a respective storage space, wherein the respective storage space of each storage compartment is configured to store one or more items, wherein each storage compartment of the plurality of storage compartments is configured to transition from a first state to a second state, wherein the first state of each respective storage compartment is configured to prevent access to the storage space of the respective storage compartment and the second state of each respective storage compartment is configured to enable access to the storage space of the respective storage compartment, and wherein each respective delivery pod is engageable with and disengageable from the first ADV. The first delivery system may further include a computing system remote and external to the first ADV, wherein the computing system is configured to communicate with the first ADV and cause the first ADV to: engage a first delivery pod of the plurality of delivery pods; and autonomously transport the first delivery pod to a first one or more locations.

In still another aspect of the present disclosure, a second delivery system is provided. The second delivery system may include first ADV comprising a storage compartment having a storage space configured to store a first item destined for delivery to a first delivery location, wherein the first ADV is configured to autonomously travel to the first delivery location; and a second ADV, wherein the first ADV is configured to transport the second ADV, and wherein the second ADV is configured to deliver the first item at the first delivery location.

In even another aspect of the present disclosure, a method is provided. The method may include arriving, by a first ADV, at a first delivery location, wherein the first ADV comprises a storage compartment having a storage space that includes one or more items destined for delivery to one or more delivery locations, wherein the one or more delivery locations include the first delivery location; and causing, by the first ADV, the storage compartment to transition from a first state in which the storage space of the storage compartment is inaccessible to a second state in which the storage space of the storage compartment is accessible.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a delivery system, in accordance with various aspects of the present disclosure.

FIGS. 2A and 2B are diagrams illustrating an example of a storage system, in accordance with various aspects of the present disclosure.

FIG. 3 is a diagram illustrating an example of delivery locations for a delivery system, in accordance with various aspects of the present disclosure.

FIG. 4 is a diagram illustrating an example of autonomous item delivery by an autonomous delivery vehicle (ADV), in accordance with various aspects of the present disclosure.

FIG. 5 is a diagram illustrating an example of a personal receiver device (PRD) in communication with a ADV, in accordance with various aspects of the present disclosure.

FIG. 6 is a flowchart illustrating an example of a method of autonomous item delivery, in accordance with various aspects of the present disclosure.

FIG. 7 is a diagram illustrating an example of a hardware implementation for an example apparatus, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of autonomous item delivery, delivery systems, and autonomous delivery vehicles (ADVs) are presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

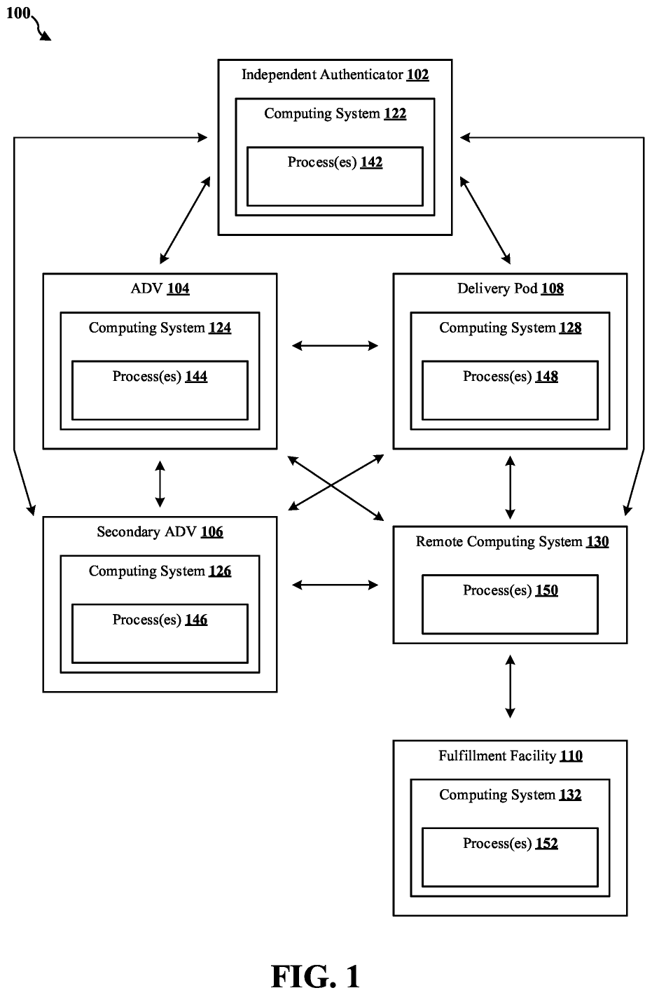

FIG. 1 illustrates an example delivery system 100 in which one or more techniques described herein may be employed. A component or a feature of any component of any example delivery system 100 may be, in some examples, as described in this disclosure, including the claims.

A delivery system 100 in accordance with this disclosure may include, separately or in combination, any component that enables delivery of one or more items to one or more locations. Various embodiments of delivery system 100 may include any combination of any depicted component and non-depicted component. For example, various embodiments of delivery system 100 may include zero or more ADVs 104, zero or more secondary ADVs 106, zero or more delivery pods 108, zero or more independent authenticators 102, zero or more remote computing systems 130, and/or zero or more fulfillment facilities 110. As another example, one embodiment of delivery system 100 may include one or more ADVs 104, one or more independent authenticators 102, one or more remote computing systems 130, and one or more fulfillment facilities 110. Another example embodiment of delivery system 100 may include one or more ADVs 104, one or more secondary ADVs 106, one or more remote computing systems 130, and one or more fulfillment facilities 110. Another example embodiment of delivery system 100 may include one or more ADVs 104, one or more delivery pods 108, one or more independent authenticators 102, one or more remote computing systems 130, and one or more fulfillment facilities 110.

In the example shown in FIG. 1, an ADV 104 and a secondary ADV 106 generally refer to an unmanned ADV. In some examples, an ADV 104 and a secondary ADV 106 may be the same type of ADV, such as an automotive ADV. In other examples, an ADV 104 is a first type of ADV and a secondary ADV 106 is a second type of ADV different from the first type. For example, the first type may be an automotive ADV and the second type may be a drone (e.g., a ground drone or a drone configured to fly) or other unmanned aerial vehicle (UAV). In such examples where ADV 104 is a first type of ADV and secondary ADV 106 is a second type of ADV, an ADV may be configured to transport a secondary ADV. In such an example, secondary ADV 106 may be configured to physically couple to and uncouple from ADV 104. In such examples where ADV 104 is a first type of ADV and secondary ADV 106 is a second type of ADV, the first type of ADV may include a storage system and the second type of ADV may not include a storage system.

Each respective component of delivery system 100 may be configured to communicate with one or more other components of the system. Example communication coupling is shown in FIG. 1 with arrows, but other examples may have different configurations of which system components may be communicatively coupled with other system components. Communication between components may utilize one or more networks and one or more communication protocols. For example, the components of FIG. 1 may be configured to utilize one or more personal area networks (PANs), local area networks (LANs), wide area networks (WANs), cellular or radio access networks, and/or other networks, which may be wired and/or wireless and which may implement Bluetooth, Wi-Fi, 4G Long Term Evolution (LTE), 5G New Radio (NR), and/or other similar wired/wireless and/or radio access protocol.

Each respective component of delivery system 100 may include a respective computing system configured to perform one or more processes or techniques described herein with respect to the respective component. The respective computing system of each respective component of delivery system 100 may be configured to cause one or more processes or techniques described herein to be performed. For example, reference to an independent authenticator 102 being configured to perform a function may refer to a computing system 122 of independent authenticator 102 being configured to perform the function; reference to an ADV 104 being configured to perform a function may refer to a computing system 124 of ADV 104 being configured to perform the function; reference to a secondary ADV 106 being configured to perform a function may refer to a computing system 126 of secondary ADV 106 being configured to perform the function; reference to a delivery pod 108 being configured to perform a function may refer to a computing system 128 of delivery pod 108 being configured to perform the function; and/or reference to a fulfillment facility 110 being configured to perform a function may refer to a computing system 132 of fulfillment facility 110 being configured to perform the function.

To that end, each of the processes of FIG. 1 may include computer-executable code in the form of instructions or data structures that can be accessed from storage or received over a network, loaded into memory, and executed by a processor(s) to cause one of the illustrated components to perform one or more functions. For example, the computing system 124 of ADV 104 may execute process(es) 144 to receive first information from remote computing system 130, and to autonomously travel to one or more locations based on the first information. In another example, the computing system 126 of secondary ADV 106 may execute process(es) 146 to autonomously travel to a delivery location, confirm that secondary ADV 106 has arrived at the correct delivery location, and autonomously deliver an item to the delivery location when secondary ADV 106 has arrived at the correct delivery location. In still another example, the computing system 128 of delivery pod 108 may be configured to execute process(es) 148 that receives authentication information (e.g., from independent authenticator 102) that authenticates a recipient and/or a delivery location, and transition from a first state, in which access to a storage space holding an item for delivery is prevented, to a second state, in which access to the storage space is enabled, in response to receiving authentication information that authenticates the recipient and/or delivery location.

In yet another example, the computing system 132 of fulfillment facility 110 may be configured to execute process(es) 152 that evaluate a delivery schedule indicating items and/or delivery pods to be delivered and, based on the evaluation of the delivery schedule, pack delivery pods and/or trailers (e.g., with items). For example, the delivery schedule may indicate some first (e.g., perishable) items for delivery, and the computing system 132 may execute process(es) 152 that result in the first items being packed or positioned so as to be accessible before some second (e.g., non-perishable) items when the first items are to be delivered before the second items. Potentially, the computing system 132 may execute process(es) 152 that result in the first items being scheduled for delivery before the second items. Thus, fulfillment facility 110 itself can be part of delivery system 100, such as by implementing some functionality to enhance, synergize, and/or otherwise facilitate localized tag-team delivery concepts (e.g., packing and cycling trailers/delivery for the ADVs). Illustratively, ADV 104 may tow or otherwise transport delivery pod 108 with one or more items to be delivered to one or more locations. While ADV 104 is performing delivery, computing system 132 may execute process(es) 152 of fulfillment facility 110 to load another delivery pod at fulfillment facility 110 so that the other delivery pod is available to be picked up when ADV 104 returns with delivery pod 108.

In still a further example, the computing system 122 of independent authenticator 102 may execute process(es) 142 that include determining that an ADV 104 and/or a secondary ADV 106 is at a delivery location (such as by receiving a message from ADV 104 and/or secondary ADV 106), and transmitting a message to ADV 104 and/or secondary ADV 106 that instructs ADV 104 and/or secondary ADV 106 to enable access to a storage space in which an item to be delivered to the delivery location is stored. For example, the message may include information authenticating a delivery recipient or delivery location. In some embodiments, the message may instruct ADV 104 and/or secondary ADV 106 to leave the item at the delivery location.

In even another example, remote computing system 130 may execute process(es) 150 that receive location and/or status information of an ADV 104 and/or a secondary ADV 106 (or a delivery person), and route (or reroute) and/or schedule (or reschedule) one or more deliveries based on the received location and/or status information. For example, remote computing system 130 may execute process(es) 150 that evaluate traffic conditions, ADV 104 status (e.g., inactive, damaged, etc.), delivery person status (e.g., illness, unavailable, etc.), and the like. Based on the evaluations (e.g., of traffic conditions, statuses, etc.), remote computing system 130 may reroute, reschedule, reassign, etc. one or more deliveries. Remote computing system 130 may execute process(es) to schedule deliveries based on one or more criteria, such as criteria to minimize or reduce energy usage, maximize or increase the number of items delivered (e.g., packaged or unpackaged), minimize or reduce the number of delivery persons used, and so forth.

In some embodiments, delivery system 100 may include a swarm-team delivery network. Such a delivery system may enable localized, sustainable e-retail personalized delivery of one or more items. The example system may or may not include a human to deliver one or more items in conjunction with any apparatus, device, or system of the example delivery system including, for example, an unmanned ADV.

In some examples, ADV 104 or other system component may serve as a mobile warehouse fed by a localized warehouse/facility (e.g., fulfillment facility 110). Such a facility may be automated (e.g., embedded in a hub and spoke warehouse system) to enable loading of the storage space corresponding to one or more storage compartments. In some examples, ADV 104 may include one or more storage compartments. In other examples, other system components, such as a trailer or delivery pod 108 may include one or more storage compartments.

A delivery person, such as a person located proximate to (e.g., in the neighborhood of) the recipient or (final) delivery location may execute the final delivery (e.g., last mile and/or last foot). Such a delivery person may be on foot or using a small e-vehicle (such as an e-bike or e-scooter) for localized, sustainable e-delivery that minimizes neighborhood traffic interruption and impact on quality of life while also reducing emissions footprint of personalized delivery.

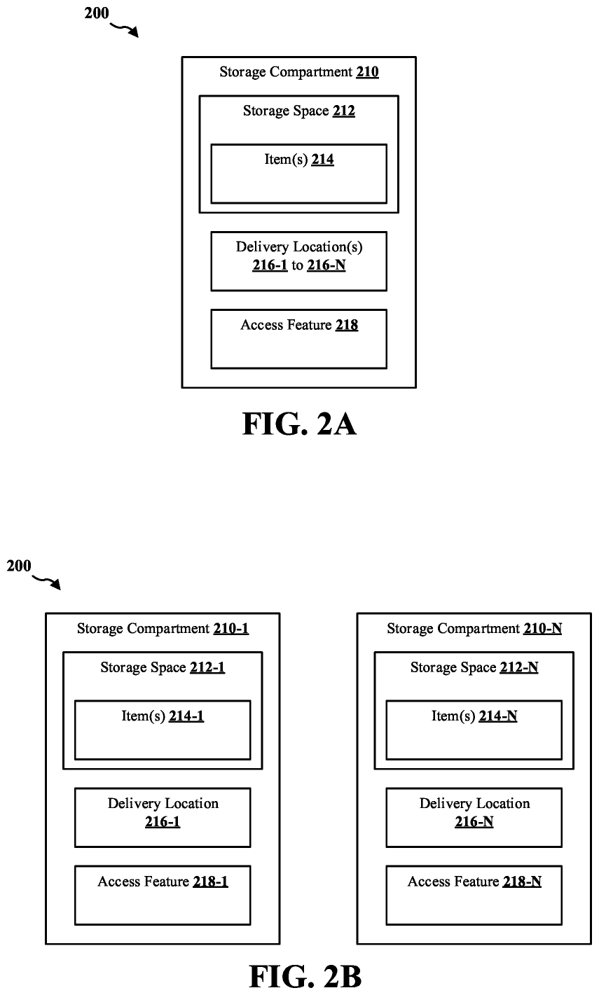

FIGS. 2A and 2B are diagrams illustrating an example of a storage system 200, in accordance with various aspects of the present disclosure. In the context of FIG. 1, an ADV 104, secondary ADV 106, and/or delivery pod 108 may include at least a portion of a storage system 200.

Storage system 200 includes a storage compartment 210 having a storage space 212 configured to store one or more items 214 destined for delivery to one or more delivery locations 216-1 to 216-N, where 216-N represents the Nth delivery location. Storage compartment 210 may include an access feature 218 (e.g., a door), which may enable a person or a secondary ADV to access one or more items stored in storage space 212 for transport to the one or more delivery locations 216-1 to 216-N. Access feature 218 may be configured to have a first state and a second state. In the first state, the one or more items 214 stored in storage space 212 may be inaccessible, such as by a secondary ADV or a person. In the second state, the one or more items 214 stored in storage space 212 may be accessible, such as by a secondary ADV or a person. Access feature 218, depending on the embodiment, may be positioned on the top, bottom, or a side of storage compartment 210. In some examples, storage space 212 may include an item positioning or retrieval system configured to position one or more items stored in storage space 212 near access feature 218. For example, if an ADV or delivery pod configured with the example storage system 200 of FIG. 2A is at delivery location 216-1, storage compartment 210 may be configured to transition from the first state to the second state, and the item positioning or retrieval system may be configured to position one or more items destined for delivery to delivery location 216-1 near access feature 218, which enables a secondary ADV to engage such items for delivery to delivery location 216-1.

FIG. 2B illustrates another example of storage system 200, which includes a plurality of storage compartments 210-1 to 210-N, where 210-N represents the Nth storage compartment of the example storage system 200. Each respective storage compartment 210-1 to 210-N may include a respective storage space 212-1 to 212-N, where 212-N represents the Nth storage space corresponding to the Nth storage compartment. Each storage space may be configured to store one or more items destined for delivery to a respective address. For example, one or more items 214-1 may be destined for delivery to delivery location 216-1 and one or more items 214-N may be destined for delivery to delivery location 216-N. Each respective storage compartment may be associated with a respective delivery location. For example, delivery location 216-1 may be associated with storage compartment 210-1 and delivery location 216-N may be associated with storage compartment 210-N. A delivery location may be associated with a storage compartment, such as at the time when the one or more items are loaded into the storage compartment. A delivery location may be disassociated from a storage compartment, such as after successful delivery of the one or more items stored therein or after the one or more items have been removed from the storage compartment at a fulfillment facility following unsuccessful delivery of the one or more items. Each respective storage compartment 210-1 to 210-N may include a respective access feature 218-1 to 218-N, where 218-N represents the Nth access feature corresponding to the Nth storage compartment. Each respective access feature 218-1 to 218-N may enable a person or a secondary ADV to access one or more items stored in each respective storage space 212-1 to 212-N for transport to the respective delivery location associated with the respective storage compartment. Each respective access feature may be configured to have a first state and a second state. The state of each of respective access feature may be independent of the state of any other access feature. In the first state, the one or more items stored in the respective storage space may be inaccessible, such as by a secondary ADV or a person. In the second state, the one or more items stored in storage space 212 may be accessible, such as by a secondary ADV or a person. A respective access feature, depending on the embodiment and position in the example storage system, may be positioned on the top, bottom, or a side of the respective storage compartment with which the access feature is associated.

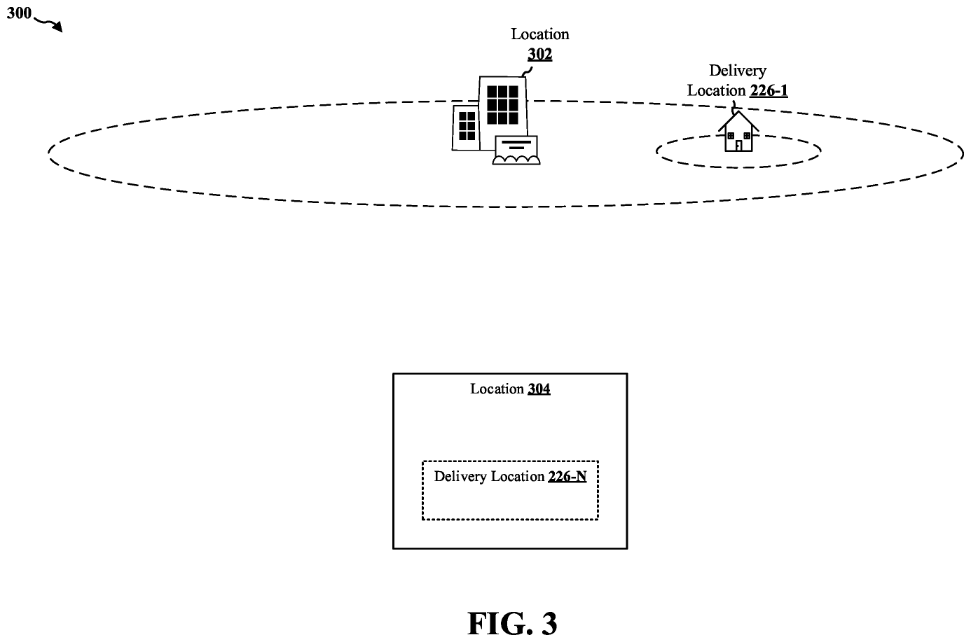

FIG. 3 is a diagram illustrating an example of delivery locations 300 for a delivery system, in accordance with various aspects of the present disclosure. While an item may be destined for delivery to a delivery location, one or more components of an example delivery system 100 may be configured travel to one or more locations different from a delivery location, such as location 302 or location 304. Both locations 302 and 304 may function as a hub location. For example, location 302 may be a location in a first neighborhood, a first regional area, a first zip code, or the like; and location 304 may be a location in a second neighborhood, a second regional area, a second zip code, or the like. For example, an ADV may be configured to travel to delivery location 226-1 to enable delivery of an item destined for delivery to delivery location 226-1 and travel to delivery location 226-N to enable delivery of an item destined for delivery to delivery location 226-N. As another example, an ADV may be configured to travel to location 302, which is different from a delivery location. At the hub location, a delivery person or the intended recipient of the item may access the item from a storage compartment. For example, the delivery person or the intended recipient may provide authentication information, which causes the access feature corresponding to the respective storage compartment to transition from the first state to the second state. For example, an ADV may travel to location 302 to enable delivery to a first plurality of delivery locations associated with a storage system (e.g., a storage system of the ADV or of a delivery pod, depending on the embodiment) and may travel to location 304 to enable delivery to a second plurality of delivery locations associated with the storage system.

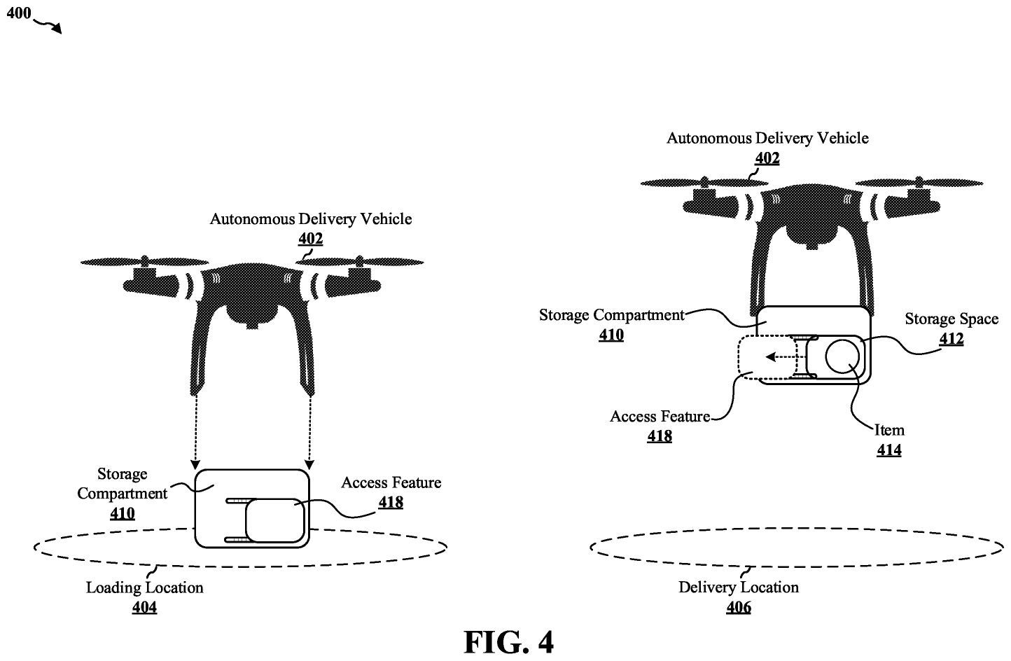

FIG. 4 is a diagram illustrating an example of autonomous item delivery 400 by an ADV 402, in accordance with various aspects of the present disclosure. ADV 402 may include a storage compartment 410 having a storage space 412 configured to store at least one item 414 (e.g., a package) destined for delivery to one or more delivery locations 406. At a loading location 404, ADV 402 may be configured to engage storage compartment 410 (e.g., a delivery pod), which may be from among a plurality of delivery pods.

Storage compartment 410 may include at least one access feature 418, such as a door, a window, a retractable opening, a releasable grip or jaws, or other such feature. When departing loading location 404, access feature 418 may be configured in a first state, in which access to item 414 stored in storage space 412 is prevented. For example, access feature 418 may include a door that is in a closed position, or access feature 418 may include a set of jaws that are closed around item 414.

ADV 402 may be configured to autonomously transport storage compartment 410 to the delivery location 406, which may be associated with item 414 and/or storage compartment 410. For example, ADV 402 may receive first information (e.g., instructions) from a computing system remote and external to ADV 402 that indicates delivery location 406. Delivery location 406 may be a location associated with storage compartment 410 and/or item 414, such as a location at which an intended recipient is located or a location having an address associated with the intended recipient, or delivery location 406 may be different from the location associated with storage compartment 410 and/or item 414, such as a distribution hub from which at secondary ADV will complete transportation of storage compartment 410 to a recipient.

In some embodiments, ADV 402 may be configured to determine that ADV 402 is at delivery location 406. For example, ADV 402 may determine that ADV 402 is the correct delivery location based on a current location of ADV 402, a distance between ADV 402 and delivery location 406, a secondary ADV configured to access storage space 412 of storage compartment 410 and transported by ADV 402 (e.g., the secondary ADV may be configured to deliver item 414 to delivery location 406), authentication information received by ADV 402 from a computing system (e.g., remote computing system 130 of FIG. 1), a secondary ADV (e.g., secondary ADV 106 of FIG. 1), or an independent authenticator (e.g., independent authenticator 102 of FIG. 1), or a distance between an independent authenticator and delivery location 406.

At delivery location 406, ADV 402 may be configured to cause storage compartment 410 to transition from a first state, in which access to item 414 is prevented, to a second state, in which access to item 414 is enabled. For example, in the second state, access feature 418 (e.g., doors or jaws) may be in an open position, allowing access storage space 412 in which item 414 is held. In some aspects, ADV 402 may authenticate the location and/or recipient before transitioning from the first state to the second state, e.g., based on authentication information. Such authentication information may include a user-initiated transition request, scanned information, or a wireless message. Examples of scanned authentication information may include information presented on a display of the independent authenticator, information stored on a radio frequency (RF) tag; scannable information; a scannable code; a barcode; a Quick Response (QR) code; a fingerprint scan information; a facial recognition scan information; and/or voice recognition scan information. ADV 402 may scan such authentication information in order to authenticate a recipient and/or delivery location associated with storage compartment 410. In some aspects, ADV 402 may be configured to deposit item 414 at delivery location 406. For example, when an independent authenticator has authorizes release of item 414, ADV 402 may cause item 414 to be placed at delivery location 406.

ADV 402 may be configured to inform an intended recipient that item 414 has arrived and/or has been delivered. For example, ADV 402 may transmit a message to the recipient when ADV 402 is within a geofence of delivery location 406. ADV 402 may receive a specific message (e.g., a coded message specific to the recipient's smart phone and/or corresponding to the address of delivery location 406 at which ADV 402 is located), which may instruct ADV 402 to transition to the second state (e.g., open access feature 418 or otherwise disengage item 414). If item 414 is not retrieved from storage compartment 410 within a predetermined time period (e.g., five minutes, ten minutes, etc.), then ADV 402 may contact a delivery person to deliver item 414 or ADV 402 may mark the delivery of item 414 as a failure and continue to the next delivery location. Item 414 may then be rescheduled for delivery at a later time and/or date.

In some embodiments, ADV 402 may be configured to remain at delivery location 406 until receiving an indication to leave (e.g., to return to loading location 404). Such an indication may be supplied by a remote computing system and/or from delivery person (e.g., receiving an indication from delivery person that item(s) was successfully delivered or not successfully delivered to the destination).

In some other aspects, a secondary ADV may transport item 414 to the intended recipient. The secondary ADV may be transported by ADV 402. Item 414 may include one or more engagement features (e.g., male and/or female receiver features) that may be engageable by the secondary ADV, and the secondary ADV may be configured to engage the engagement feature to deliver item 414 to the intended recipient and/or delivery location associated with storage compartment 410.

ADV 406 may be configured to update a delivery status of item 414. For example, ADV 406 may transmit a message to a remote computing system indicating that item 414 was successfully delivered when ADV 406 deposits item 414 at delivery location 406 or the recipient removes item 414 from storage space 412. However, ADV 406 may transmit a message to a remote computing system indicating that item 414 was not successfully delivered when ADV 406 fails to deposit item 414 at delivery location 406 or the recipient fails to remove item 414 from storage space 412. When ADV 410 is configured to include multiple storage compartments, such messages may indicate which storage compartments are empty (e.g., upon successful delivery) and which are not empty (e.g., upon unsuccessful delivery).

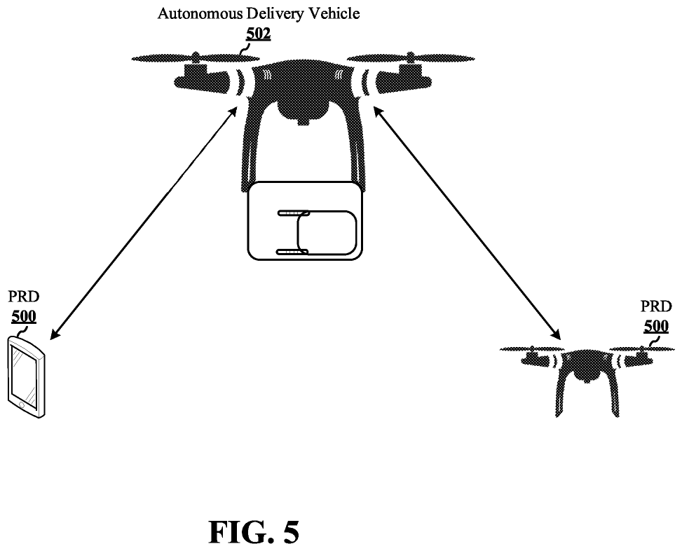

FIG. 5 is a diagram illustrating an example of a personal receiver device (PRD) 500 in communication with an ADV 502, in accordance with various aspects of the present disclosure. In some aspects, PRD 500 may be a mobile device, such as a smartphone or tablet computer, or PRD 500 may be another computing device, such as a laptop computer. PRD 500 may be implemented as or with an independent authenticator. For example, PRD 500 may be a smartphone app. PRD 500 may enable crowdsourced delivery personnel. For example, PRD 500 may an receive instructions (e.g., from a remote computing system) based on crowdsourcing of a delivery person that is closest to a delivery location at a scheduled delivery time.

Potentially, PRD 500 may provide some assistance functionality. For example, a local delivery person can serve a dual purpose of delivery and product assistance. A remote computing system and/or PRD 500 can receive a message from a recipient requesting assistance with a delivered item, e.g., after delivery of product (e.g., help with operating product), during delivery of product (e.g., installation/setup of product), or a meeting for assistance with an item can be scheduled.

In some other aspects, PRD 500 may be a secondary ADV, another autonomous guided vehicle (AGV) (e.g., a drone), or the like. PRD 500 may receive instructions (e.g., from a remote computing system or from ADV 502) instructing PRD 500 to deliver an item. For example, PRD 500 may be deployed from the top of ADV 502, such as when PRD 500 is a drone. Sensors in and/or on PRD 500, which may include vision systems, GPS and/or other navigation system, may facilitate accurate delivery. For example, a navigation system may direct PRD 500 to the right location for item drop-off (e.g., in front of the front door of a delivery location). The vision system may provide information to confirm the delivery address accuracy by scanning the neighborhood or address information and confirming the address. Once this confirmation is generated, PRD 500 may deposit the item at the appropriate location and may either return to ADV 502 or complete other item deliveries.

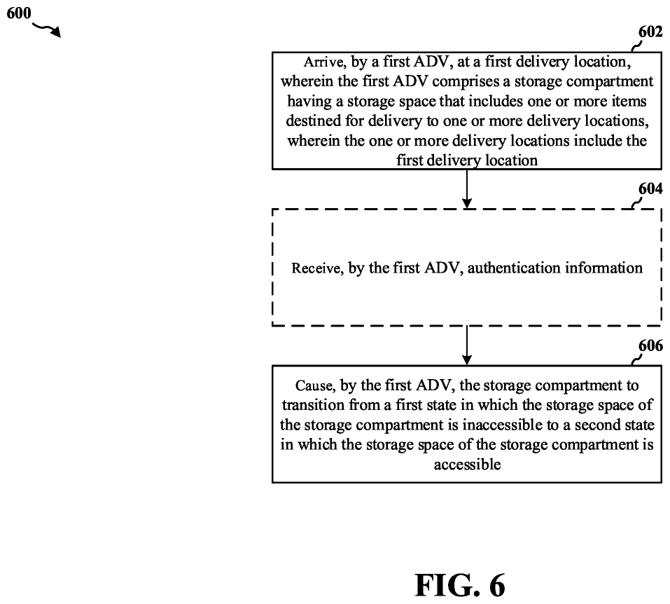

FIG. 6 is a flowchart illustrating an example of a method 600 of autonomous item delivery, in accordance with various aspects of the present disclosure. The method 600 may be performed by a computing system, such as computing system 122 of independent authenticator 102, computing system 124 of ADV 104, computing system 126 of secondary ADV 106, remote computing system 130, and/or another computing system.

At 602, the first ADV may arrive at a first delivery location. The first ADV may include a storage compartment having a storage space that includes one or more items destined for delivery to one or more delivery locations, and the one or more delivery locations may include the first delivery location.

At 604, the first ADV may receive authentication information. In some aspects, the authentication information is received from an independent authenticator. For example, the independent authenticator may include a smart phone, a laptop computer, a tablet computer, or a mobile computing device. The authentication information may include a user-initiated transition request, scanned information, or a wireless message. Illustratively, the scanned information may include information presented on a display of an independent authenticator; information stored on an RF tag; scannable information; a scannable code; a barcode; a QR code; fingerprint scan information; facial recognition scan information; or voice recognition scan information.

At 606, the first ADV may cause the storage compartment to transition from a first state in which the storage space of the storage compartment is inaccessible to a second state in which the storage space of the storage compartment is accessible. In some aspects, causing the storage compartment to transition from the first state to the second state is performed based on the authentication information. For example, the independent authenticator may be configured to run an application configured to cause the storage compartment to transition from the first state to the second state. In some other aspects, causing the storage compartment to transition from the first state to the second state is performed based on a current location of the first ADV. In still other aspects, causing the storage compartment to transition from the first state to the second state is performed based on a distance between the first ADV and the first delivery location. In yet other aspects, causing the storage compartment to transition from the first state to the second state is performed based on a second ADV transported by the first ADV needing access to the storage space of the storage compartment.

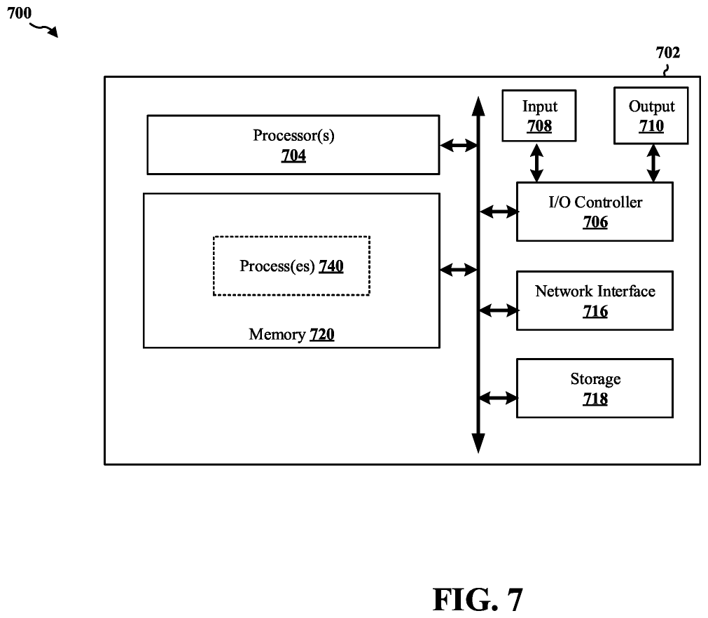

FIG. 7 is a diagram illustrating an example of a hardware implementation 700 for an example apparatus 702, in accordance with various aspects of the present disclosure. The apparatus 702 may be a computing system or similar device(s), or the apparatus 702 may be a component of a computing system or similar device(s). The apparatus 702 may include a processor(s) 704 and a memory 720, which may be coupled together and/or integrated into the same package, component, circuit, chip, and/or other circuitry. The processor(s) 704 may include, for example, a CPU, GPU, application processor, SoC, microprocessor, and/or other processor(s). The memory 720 may include, for example, RAM, ROM, and/or other memory configured to store computer-executable instructions. The processor(s) 704 and memory 720 may be configured to perform various aspects described in connection with one or more components of delivery system 100 described in connection with FIG. 1.

The apparatus 702 may further include an I/O controller 706, a network interface 716, and storage 718. The I/O controller 706 may be coupled to an input 708, which may include one or more input devices, such as a keyboard, mouse, touchscreen, a microphone, and the like. The I/O controller 706 may be further coupled to an output 710, which may include one or more output devices, such as a display, a speaker, a haptic feedback device, and the like. The network interface 716 may connect the apparatus 702 with one or more other computing systems over at least one network, which may be wired or wireless. For example, the network interface 716 may enable a connection to the Internet, a LAN, a WAN, a PAN, an enterprise network, and/or one or more other networks. The storage 718 may include volatile and/or non-volatile storage or memory, such as RAM, ROM, EEPROM, optical disk storage, magnetic disk storage, other magnetic storage devices, combinations of the aforementioned types of computer-readable media, or any other medium that can be used to store computer-executable code in the form of instructions or data structures that can be accessed by a computer.

The processor(s) 704, with the memory 720, may be responsible for general processing, including the execution of instructions stored in the memory 720 (e.g., a non-transitory computer-readable medium/memory). The instructions, when executed by the processor(s) 704, may cause the processor(s) 704 to perform various functions described supra. The memory 720 may also be used for storing data that is manipulated by the processor(s) 704 when executing instructions.

The processor(s) 704 may execute instructions of process(es) 740, which may be fetched into memory 720 for execution by the processor(s) 704. Process(es) 740 may include any of the functions described herein, such as the operations described with respect to FIGS. 1-6, supra.

The apparatus 702 may include additional components that perform some or all of the blocks, operations, signaling, etc. of the algorithm(s) in the above-described FIGS. 1-6. As such, some or all of the blocks, operations, signaling, etc. in FIGS. 1-6 may be performed by one or more components and the apparatus 702 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

The following examples are illustrative only and may be combined with aspects of other embodiments or teachings described herein, without limitation.

Example 1 may include a first ADV comprising: a plurality of storage compartments, wherein each storage compartment of the plurality of storage compartments has a respective storage space, wherein each storage compartment of the plurality of storage compartments is associated with a respective delivery location, wherein the respective storage space of each storage compartment is configured to store one or more items, wherein each storage compartment is configured to transition from a first state to a second state, and wherein the first state of each respective storage compartment is configured to prevent access to the storage space of the respective storage compartment and the second state of each respective storage compartment is configured to enable access to the respective storage space of the respective storage compartment; and a receiver configured to receive first information from a computing system remote and external to the first ADV, wherein the first ADV is configured to autonomously travel to one or more locations based on the first information.

Example 2 may include the first ADV of Example 1, wherein the one or more locations include one or more delivery locations associated with the plurality of storage compartments or one or more locations different from the delivery locations associated with the plurality of storage compartments.

Example 3 may include the first ADV of Example 1, wherein the first ADV is configured to cause each respective storage compartment of the plurality of storage compartments to transition from the first state to the second state based on: a current location of the first ADV; a distance between the first ADV and the respective delivery location associated with the respective storage compartment; a second ADV transported by the first ADV needing access to the respective storage space of the respective storage compartment, wherein the second ADV is configured to deliver the one or more items stored in the respective storage compartment to the respective delivery location; authentication information received by the first ADV from the computing system, the second ADV, or an independent authenticator; or a distance between the independent authenticator and the respective delivery location associated with the respective storage compartment.

Example 4 may include the first ADV of Example 3, wherein the independent authenticator includes a smart phone, a laptop computer, a tablet computer, or a mobile computing device.

Example 5 may include the first ADV of Example 4, wherein the independent authenticator is configured to run an application configured to cause a respective storage compartment to transition from the first state to the second state.

Example 6 may include the first ADV of Example 3, wherein the authentication information includes a user-initiated transition request, scanned information, or a wireless message.

Example 7 may include the first ADV of Example 6, wherein the scanned information includes: information presented on a display of the independent authenticator; information stored on an RF tag; scannable information; a scannable code; a barcode; a QR code; fingerprint scan information; facial recognition scan information; or voice recognition scan information.

Example 8 may include the first ADV of Example 1, wherein the first ADV is configured to autonomously travel to the one or more locations by being configured to communicate with the computing system.

Example 9 may include the first ADV of Example 1, wherein the computing system is configured to monitor a position of the first ADV.

Example 10 may include the first ADV of Example 1, wherein the first ADV is configured to communicate delivery status information to the computing system.

Example 11 may include the first ADV of Example 10, wherein the delivery status information includes a successful delivery notification or a delivery failure notification.

Example 12 may include the first ADV of Example 10, wherein the delivery status information includes information indicative of which storage compartments of the plurality of storage compartments are empty.

Example 13 may include the first ADV of Example 1, wherein the one or more items include one or more packages.

Example 14 may include the first ADV of Example 13, wherein a respective package stored in a respective storage compartment of the plurality of storage compartments includes an engagement feature engageable by a second ADV transported by the first ADV, wherein the second ADV is configured to engage the engagement feature to deliver the respective package stored in the respective storage compartment to the respective delivery location associated with the respective storage compartment.

Example 15 may include the first ADV of Example 1, wherein the first information comprises one or more instructions.

Example 16 may be an ADV comprising: a storage compartment having a storage space configured to store at least one item destined for delivery to one or more delivery locations, wherein the storage compartment transitions from a first state to a second state based on authentication information received from an independent authenticator, wherein the first state of the storage compartment is configured to prevent access to the storage space and the second state of the storage compartment is configured to enable access to the storage space; and a receiver configured to receive first information from a computing system remote and external to the ADV, wherein the ADV is configured to autonomously travel to the one or more delivery locations based on the first information.

Example 17 may include the ADV of Example 16, wherein the storage compartment is configured to transition from the first state to the second state based on: a current location of the ADV; a distance between the ADV and one of the one or more delivery locations; or a distance between the independent authenticator and one of the one or more delivery locations.

Example 18 may include the ADV of Example 16, wherein the independent authenticator includes a smart phone, a laptop computer, a tablet computer, or a mobile computing device.

Example 19 may include the ADV of Example 16, wherein the independent authenticator is configured to run an application configured to cause the storage compartment to transition from the first state to the second state.

Example 20 may include the ADV of Example 16, wherein the authentication information includes a user-initiated transition request, scanned information, or a wireless message.

Example 21 may include the ADV of Example 20, wherein the scanned information includes: information presented on a display of the independent authenticator; information stored on an RF tag; scannable information; a scannable code; a barcode; a QR code; fingerprint scan information; facial recognition scan information; or voice recognition scan information.

Example 22 may include the ADV of Example 16, wherein the ADV is configured to autonomously travel to the one or more delivery locations by being configured to communicate with the computing system.

Example 23 may include the ADV of Example 22, wherein the computing system is configured to monitor a current location of the ADV.

Example 24 may include the ADV of Example 22, wherein the ADV is configured to communicate delivery status information to the computing system.

Example 25 may include the ADV of Example 24, wherein the delivery status information includes a successful delivery notification or a delivery failure notification.

Example 26 may include the ADV of Example 16, wherein the first information comprises one or more instructions.

Example 27 may be a delivery system comprising: a first ADV; a plurality of delivery pods, wherein each delivery pod comprises a plurality of storage compartments, wherein each storage compartment of the plurality of storage compartments is associated with a respective delivery location, wherein each storage compartment of the plurality of storage compartments has a respective storage space, wherein the respective storage space of each storage compartment is configured to store one or more items, wherein each storage compartment of the plurality of storage compartments is configured to transition from a first state to a second state, wherein the first state of each respective storage compartment is configured to prevent access to the storage space of the respective storage compartment and the second state of each respective storage compartment is configured to enable access to the storage space of the respective storage compartment, and wherein each respective delivery pod is engageable with and disengageable from the first ADV; and a computing system remote and external to the first ADV, wherein the computing system is configured to communicate with the first ADV and cause the first ADV to: engage a first delivery pod of the plurality of delivery pods; and autonomously transport the first delivery pod to a first one or more locations.

Example 28 may include the delivery system of Example 27, wherein the computing system is configured to cause the first ADV to: autonomously transport the first delivery pod to a second location; disengage from the first delivery pod at the second location; engage a second delivery pod at the second location or a third location; and autonomously transport the second delivery pod to a second one or more locations.

Example 29 may include the delivery system of Example 28, wherein the first ADV is configured to cause each respective storage compartment of the plurality of storage compartments of a respective delivery pod to transition from the first state to the second state based on: a current location of the first ADV; a distance between the first ADV and the respective delivery location associated with the respective storage compartment; a second ADV transported by the first ADV needing access to the respective storage space of the respective storage compartment, wherein the second ADV is configured to deliver the one or more items stored in the respective storage compartment to the respective delivery location; authentication information received by the first ADV from the computing system, the second ADV, or an independent authenticator; or a distance between the independent authenticator and the respective delivery location associated with the respective storage compartment.

Example 30 may be a delivery system comprising: a first ADV comprising a storage compartment having a storage space configured to store a first item destined for delivery to a first delivery location, wherein the first ADV is configured to autonomously travel to the first delivery location; and a second ADV, wherein the first ADV is configured to transport the second ADV, and wherein the second ADV is configured to deliver the first item at the first delivery location.

Example 31 may include the delivery system of Example 30, wherein the second ADV is configured to couple to the first ADV and uncouple from the first ADV.

Example 32 may include the delivery system of Example 30, wherein the second ADV is configured to be coupled to the first ADV while the first ADV travels to the first delivery location.

Example 33 may include the delivery system of Example 30, wherein the second ADV is configured to uncouple from the first ADV at the first delivery location.

Example 34 may include the delivery system of Example 33, wherein the second ADV is configured to couple to the first ADV after the second ADV completes delivery of the first item to the first delivery location.

Example 35 may include the delivery system of Example 30, wherein the storage space is configured to store a second item destined for delivery to a second delivery location, and wherein the first ADV is configured to autonomously travel to the second delivery location from the first delivery location.

Example 36 may include the delivery system of Example 35, wherein the second ADV is configured to be coupled to the first ADV while the first ADV travels to the second delivery location.

Example 37 may include the delivery system of Example 35, wherein the second ADV is configured to charge a battery of the second ADV while coupled to the first ADV.

Example 38 may include the delivery system of Example 35, wherein the second ADV is configured to uncouple from the first ADV at the second delivery location.

Example 39 may include the delivery system of Example 38, wherein the second ADV is configured to couple to the first ADV after the second ADV completes delivery of the second item to the second delivery location.

Example 40 may include the delivery system of Example 30, wherein the first item includes a package.

Example 41 may include the delivery system of Example 40, wherein the package includes an engagement feature engageable by the second ADV.

Example 42 may include the delivery system of Example 41, wherein the second ADV is configured to engage the engagement feature to deliver the first item to the first delivery location.

Example 43 may be a method comprising: arriving, by a first ADV, at a first delivery location, wherein the first ADV comprises a storage compartment having a storage space that includes one or more items destined for delivery to one or more delivery locations, wherein the one or more delivery locations include the first delivery location; and causing, by the first ADV, the storage compartment to transition from a first state in which the storage space of the storage compartment is inaccessible to a second state in which the storage space of the storage compartment is accessible.

Example 44 may include the method of Example 43, further comprising receiving, by the first ADV, authentication information, wherein causing the storage compartment to transition from the first state to the second state is performed based on the authentication information.

Example 45 may include the method of Example 44, wherein the authentication information is received from an independent authenticator.

Example 46 may include the method of Example 45, wherein the independent authenticator includes a smart phone, a laptop computer, a tablet computer, or a mobile computing device.

Example 47 may include the method of Example 46, wherein the independent authenticator is configured to run an application configured to cause the storage compartment to transition from the first state to the second state.

Example 48 may include the method of Example 44, wherein the authentication information includes a user-initiated transition request, scanned information, or a wireless message.

Example 49 may include the method of Example 48, wherein the scanned information includes: information presented on a display of an independent authenticator; information stored on an RF tag; scannable information; a scannable code; a barcode; a QR code; fingerprint scan information; facial recognition scan information; or voice recognition scan information.

Example 50 may include the method of Example 43, wherein causing the storage compartment to transition from the first state to the second state is performed based on a current location of the first ADV.

Example 51 may include the method of Example 43, wherein causing the storage compartment to transition from the first state to the second state is performed based on a distance between the first ADV and the first delivery location.

Example 52 may include the method of Example 43, wherein causing the storage compartment to transition from the first state to the second state is performed based on a second ADV transported by the first ADV needing access to the storage space of the storage compartment.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A first autonomous delivery vehicle (ADV) comprising:
a plurality of storage compartments, wherein each storage compartment of the plurality of storage compartments has a respective storage space, wherein each storage compartment of the plurality of storage compartments is associated with a respective delivery location, wherein the respective storage space of each storage compartment is configured to store one or more items, wherein each storage compartment is configured to transition from a first state to a second state, and wherein the first state of each respective storage compartment is configured to prevent access to the storage space of the respective storage compartment and the second state of each respective storage compartment is configured to enable access to the respective storage space of the respective storage compartment; and
a receiver configured to receive first information from a computing system remote and external to the first ADV, wherein the first ADV is configured to autonomously travel to one or more locations based on the first information.

2. The first ADV of claim 1, wherein the one or more locations include one or more delivery locations associated with the plurality of storage compartments or one or more locations different from the delivery locations associated with the plurality of storage compartments.

3. The first ADV of claim 1, wherein the first ADV is configured to cause each respective storage compartment of the plurality of storage compartments to transition from the first state to the second state based on:
a current location of the first ADV;
a distance between the first ADV and the respective delivery location associated with the respective storage compartment;
a second ADV transported by the first ADV needing access to the respective storage space of the respective storage compartment, wherein the second ADV is configured to deliver the one or more items stored in the respective storage compartment to the respective delivery location;
authentication information received by the first ADV from the computing system, the second ADV, or an independent authenticator; or
a distance between the independent authenticator and the respective delivery location associated with the respective storage compartment.

4. The first ADV of claim 3, wherein the independent authenticator includes a smart phone, a laptop computer, a tablet computer, or a mobile computing device.

5. The ADV of claim 4, wherein the independent authenticator is configured to run an application configured to cause a respective storage compartment to transition from the first state to the second state.

6. The first ADV of claim 3, wherein the authentication information includes a user-initiated transition request, scanned information, or a wireless message.

7. The first ADV of claim 6, wherein the scanned information includes:
information presented on a display of the independent authenticator;
information stored on a radio frequency (RF) tag;
scannable information;
a scannable code;
a barcode;
a Quick Response (QR) code;
fingerprint scan information;
facial recognition scan information; or
voice recognition scan information.

8. The first ADV of claim 1, wherein the first ADV is configured to autonomously travel to the one or more locations by being configured to communicate with the computing system.

9. The first ADV of claim 1, wherein the computing system is configured to monitor a position of the first ADV.

10. The first ADV of claim 1, wherein the first ADV is configured to communicate delivery status information to the computing system.

11. The first ADV of claim 10, wherein the delivery status information includes a successful delivery notification or a delivery failure notification.

12. The first ADV of claim 10, wherein the delivery status information includes information indicative of which storage compartments of the plurality of storage compartments are empty.

13. The first ADV of claim 1, wherein the one or more items include one or more packages.

14. The first ADV of claim 13, wherein a respective package stored in a respective storage compartment of the plurality of storage compartments includes an engagement feature engageable by a second ADV transported by the first ADV, wherein the second ADV is configured to engage the engagement feature to deliver the respective package stored in the respective storage compartment to the respective delivery location associated with the respective storage compartment.

15. The first ADV of claim 1, wherein the first information comprises one or more instructions.

16. An autonomous delivery vehicle (ADV) comprising:
a storage compartment having a storage space configured to store at least one item destined for delivery to one or more delivery locations, wherein the storage compartment transitions from a first state to a second state based on authentication information received from an independent authenticator, wherein the first state of the storage compartment is configured to prevent access to the storage space and the second state of the storage compartment is configured to enable access to the storage space; and
a receiver configured to receive first information from a computing system remote and external to the ADV, wherein the ADV is configured to autonomously travel to the one or more delivery locations based on the first information.

17. The ADV of claim 16, wherein the storage compartment is configured to transition from the first state to the second state based on:
a current location of the ADV;
a distance between the ADV and one of the one or more delivery locations; or
a distance between the independent authenticator and one of the one or more delivery locations.

18. The ADV of claim 16, wherein the independent authenticator includes a smart phone, a laptop computer, a tablet computer, or a mobile computing device.

19. A method comprising:
arriving, by a first autonomous delivery vehicle (ADV), at a first delivery location, wherein the first ADV comprises a storage compartment having a storage space that includes one or more items destined for delivery to one or more delivery locations, wherein the one or more delivery locations include the first delivery location; and
causing, by the first ADV, the storage compartment to transition from a first state in which the storage space of the storage compartment is inaccessible to a second state in which the storage space of the storage compartment is accessible.

20. The method of claim 19, further comprising receiving, by the first ADV, authentication information, wherein causing the storage compartment to transition from the first state to the second state is performed based on the authentication information.
